(19) United States
(12) Patent Application Publication
(10) Pub. No.: US 2007/0244204 A1
(43) Pub. Date: Oct. 18, 2007

(54) Rheology enhancers in non-oilfield applications

(76) Inventors: Evelyne Prat, Pantin (FR); Manilal S. Dahanayake, Princeton Junction, NJ (US); Allwyn Colaco, South River, NJ (US); Robert J. Tillotson, Toms River, NJ (US); Fang Li, Pleasanton, CA (US)

Correspondence Address: MIALEEKA WILLIAMS;RHODIA INC., 8 CEDAR BROOK DRIVE (CN 7500), CRANBURY, NJ, 08512-7500, US

(21) Appl. No.: 11/403,713

(22) Filed: Apr. 13, 2006

(51) Int. Cl. B01F 3/08; B01F 17/00; C09K 3/00

(52) U.S. Cl. 516/58; 516/200

(57) ABSTRACT

A method for increasing the rate of shear rehealing of fluids made with cationic, zwitterionic, and amphoteric viscoelastic surfactant fluid systems by adding an effective amount of a rheology enhancer package containing, for example a polyethylene glycol—polypropylene glycol block copolymer and a polynaphthalene sulfonate. The rheology enhancer package allows viscoelastic surfactant fluids to be used at lower viscoelastic surfactant concentrations in certain non-oilfield excavation applications, for example boring, excavating, drilling and trenching operations in deep foundation construction, subterranean construction, and tunneling. Preferred surfactants are betaines and quaternary amines.

### BACKGROUND OF THE INVENTION

The invention relates to viscoelastic surfactant fluid systems. More particularly it relates to rheology enhancers for viscoelastic surfactant fluid systems for use in non-oilfield geological excavation applications that increases the thermal stability of the systems and shortens the time they take to heal after shearing.

Certain surfactants, when in aqueous solution exhibit viscoelastic characteristics. Such surfactants are termed “viscoelastic surfactants”, or “VES”. Other components, such as additional VES's, co-surfactants, buffers, acids, solvents, and salts, are optional or necessary (depending upon the specific VES and the intended use) and perform such functions as increasing the stability (especially thermal stability) or increasing the viscosity of the systems by modifying and/or stabilizing the micelles. All the components together are generally referred to as a VES fluid system or viscoelastic fluid system. Hereinafter, for simplicity, we shall refer to these systems as “VES fluid systems”.

Not to be limited by theory, but many viscoelastic surfactants form long rod-like or worm-like micelles in aqueous solution. Entanglement of these micelle structures gives viscosity and elasticity to the fluid. For a fluid to have good viscosity and elasticity under given conditions, proper micelles must be formed and proper entanglement is needed. Thus VES structures must meet certain geometric requirements and the micelles must be of sufficient length or interconnections for adequate entanglements.

Many chemical additives are known to improve rheology attributes, such as viscosity, stability, brine tolerance, shear sensitivity, rehealing if micelles are disrupted, for example by shear. Such additives are typically referred to as co-surfactants, rheology modifiers, or rheology enhancers. They typically are alcohols; organic acids, such as carboxylic acids and sulfonic acids; or sulfonates. Herein the term rheology enhancer(s) shall be used to refer to any such additive. Rheology enhancers often have different effects, depending upon their exact composition and concentration, relative to the exact surfactant composition and concentration. For example, rheology enhancers may be beneficial at some concentrations and harmful (for example, causing lower viscosity, reduced stability, greater shear sensitivity, longer rehealing times) at others.

In particular, many VES fluid systems exhibit long viscosity recovery times after experiencing prolonged high shear. Slow recovery of viscosity after shear means that higher concentrations of the VES fluid system must be used. Slow recovery negatively impacts drag reduction and transport capability of excavated earth, or materials. For example, slow recovery can negatively impact the ability to carry earth or excavated materials during boring, excavating, drilling and trenching operations in deep foundation construction, subterranean construction, and tunneling. One way that the expense of higher viscoelastic surfactant concentrations can be offset is to use shear recovery enhancers and/or shear rehealing accelerators that allow the use of lower VES fluid systems concentrations.

As discussed above, when fluids, particularly excavation fluids, are viscosified by the addition of VES fluid systems, the viscosity increase is believed to be due to the formation of micelles, for example worm-like micelles, which entangle to give structure to the fluid that leads to viscosity. In addition to the viscosity itself, an important aspect of a fluid's properties is the degree and rate of viscosity-recovery or rehealing when the fluid is subjected to high shear and the shear is then reduced. For VES fluid systems, shear may disrupt the micelle structure, but the structure reassembles. Controlling the degree and rate of reassembling (also referred to as recovery and hereinafter referred to as “rehealing”) is necessary to maximize performance of the VES fluid system for various applications.

Earth pressure balance shield tunnel boring machines are frequently used in cohesive soils with good plastic properties, but these machines face some difficulties when the soil is too thick or sticky. One solution described in WO 99/18330 is to inject, at the cutting head, a foamed aqueous material that renders the soil more pliable so that the soil passes easily through the cutting head into the excavation chamber. At this point, the soil must not be too fluid since it could result into an unwanted flow behind the shield and it would not be removed easily through a conveyor (generally a screw type conveyor). An attempt to fix the problem has been described in U.S. Pat. No. 6,802,673, where a first aqueous foamed solution is injected in the cutting head to improve the plasticity of the soil and where a second aqueous solution is added after the soil has reached the excavation chamber to stiffen the soil and facilitates its removal.

It would be desirable to provide an economic means to improve soil pliability characteristics in non-oilfield excavation applications.

### SUMMARY OF THE INVENTION

In one embodiment of the invention there is provided a fluid comprising a viscoelastic surfactant selected from the group consisting of zwitterionic, amphoteric, and cationic surfactants and mixtures thereof, a rheology enhancer in an amount sufficient to increase the rate of shear rehealing of said fluid, said rheology enhancer comprising a first component comprising a block copolymer of polypropylene glycol and polyethylene glycol and a second component comprising a polynaphthalene sulfonate; and a liquid solution.

In yet another embodiment there is provided a process of forming a fluid for non-oilfield excavations comprising the steps of:
i). mixing at least a surfactant composition comprising a) a surfactant selected from the group consisting of zwitterionic, amphoteric, cationic, and mixtures thereof, and b) a rheology enhancer composition present in an amount sufficient to increase the rate of shear recovery, wherein said rheology enhancer composition comprises at least a block copolymer of polypropylene glycol and polyethylene glycol, and a polynaphthalene sulfonate to form a rheology enhancer containing surfactant system;
ii). adding a liquid carrier solution to said rheology enhancer containing surfactant system to form a fluid. The rheology enhancer containing surfactant system is preferably non-viscous. Thus, there is also further provided a process for increasing the viscosity of a fluid described above by agitating the fluid to form a viscoelastic fluid system.

In still yet another embodiment of the invention there is provided a method of treating a non-oilfield excavation site comprising:
a) providing a viscoelastic surfactant composition comprising at least a zwitterionic surfactant, amphoteric surfactant, cationic surfactant or combination thereof;
b) adding a rheology enhancer to said viscoelastic surfactant composition, wherein said rheology enhancer package comprises at least a polynaphthalene sulfonate component and a block copolymer component, wherein said block copolymer component comprises polypropylene glycol and polyethylene glycol;
c) mixing said viscoelastic surfactant composition and said rheology enhancer to form a fluid having viscoelastic properties; and
d) injecting said fluid into a non-oilfield excavation application.

In yet a further embodiment, the fluid further contains a member selected from amines, alcohols, glycols, organic salts, chelating agents, solvents, mutual solvents, organic acids, organic acid salts, inorganic salts, oligomers, and mixtures of these members. The member is present, for example, at a concentration of between about 0.01 and about 10 percent, for example at a concentration of between about 0.01 and about 1 percent.

In yet another embodiment, the VES fluids system includes a surfactant or mixture of surfactants containing an amphoteric surfactant having an amine oxide, for example an amidoamine oxide.

In another embodiment, the first component is present in the fluid at a concentration of from about 0.005% to about 1 weight %, for example at a concentration of from about 0.01 weight % to about 0.5 weight %. The second component is present in the fluid at a concentration of from about 0.005% to about 1 weight %, for example at a concentration of from about 0.01 weight % to about 0.5 weight %.

In still another embodiment, the block copolymer has a mole ratio of polyethylene glycol to polypropylene glycol, for example, of from about 1:1 to about 1:2. The block copolymer may have an inner block containing polyethylene glycol and outer blocks containing polypropylene glycol, or an inner block containing polypropylene glycol and outer blocks containing polyethylene glycol. The block copolymer may have a molecular weight of from about 1000 to about 18,000. The polynaphthalene sulfonate polymer may have a molecular weight of from about 5000 to about 500,000. The weight ratio of the first component (block copolymer) to the second component (polynaphthalene sulfonate) in the fluid depends upon the exact choice of each component, but is, for example, from about 1:5 to about 1:1, preferably from about 1:2 to about 1:3.

In yet another embodiment the fluid also contains an acid selected from hydrochloric acid, hydrofluoric acid, formic acid, acetic acid, polylactic acid, polyglycolic acid, lactic acid, glycolic acid, sulfamic acid, malic acid, citric acid, tartaric acid, maleic acid, methylsulfamic acid, chloroacetic acid and mixtures of these acids.

In still yet another embodiment, the first component comprises a non-linear copolymer having a structure selected from star, comb, dendritic, brush, graft, or star-branched.

Another embodiment is a method of increasing the rate of shear rehealing of a viscoelastic fluid made with a VES fluids system including the steps of a) providing a fluid containing a viscoelastic surfactant selected from zwitterionic, amphoteric, and cationic surfactants and mixtures of these surfactants, and b) adding to the fluid a rheology enhancer at a concentration sufficient to increase the rate of shear rehealing of the fluid, the rheology enhancer containing a first component comprising a block copolymer of polypropylene glycol and polyethylene glycol and a second component comprising a polynaphthalene sulfonate.

Yet another embodiment is a method of using the fluids described above in non-oilfield excavation sites including, for example, subterranean construction, tunneling, mining, road construction, roads, bridge construction, building construction and the likes. Fluids in accordance with the invention may be used as additives to modify the rheology of non-oilfield excavation site by-product so as to facilitate the transportation of these by-products for injection or removal from the site.

Still yet another embodiment is a method of using the foam described above for use in tunnel boring machines. When foams in accordance with the invention are used in tunnel boring machines they are useful in a) improving lubrication and protection of the cutting disk thereby preventing blade damage; b) helping to reduce the permeability of the soil; c) improving the removal of soil during the boring processing; and d) facilitating the removal of the excavated soil thru a conveying means, for example, a screw conveyor.

Another embodiment is a method of using the foam described above for the manufacture of low density materials such as pre-cast slabs, ceramics, and the like.

An additional embodiment is a method of using the foam or fluids described above for use in high pressure cleaners such as industrial cleaners, automobile cleaners, and other cleaners where it is useful for the fluids or foams to stick to a surface, for example, a vertical surface to improve cleaning.

In another additional embodiment there is provided a method of using the fluids or foam described above in home and personal care applications.

### BRIEF DESCRIPTION OF THE DRAWINGS

FIG. 1 shows the viscosity as a function of temperature for various concentrations of a viscoelastic surfactant fluid containing a rheology enhancer of the invention.

FIG. 2 shows the viscosity as a function of temperature for fluids containing a constant amount of a viscoelastic surfactant and of one component of a rheology enhancer of the invention, and varying amounts of a second component of a rheology enhancer of the invention.

FIG. 3 shows the effect of varying concentrations of one component of a rheology enhancer of the invention on shear recovery time of a fluid containing several concentrations of viscoelastic surfactant and a constant ratio of a second component of the rheology enhancer to the viscoelastic surfactant.

FIG. 4 compares the viscosities of fluids made with the same concentration of a viscoelastic surfactant and the same concentration of one component of a rheology enhancer of the invention, and different concentrations of two examples of a second component of the rheology enhancer.

FIG. 5 shows the effect of varying the concentration of one example of a block copolymer component of the rheology enhancer of the invention in a viscoelastic surfactant fluid as a function of temperature.

FIG. 6 shows the effect on the low shear viscosity of varying the concentration of one example of a block copolymer component of a rheology enhancer of the invention in a viscoelastic surfactant fluid, while keeping the concentration of a second component constant.

FIG. 7 shows the effect on the dynamic loss modulus and dynamic storage modulus of varying the concentration of one example of a block copolymer component of a rheology enhancer of the invention in a viscoelastic surfactant fluid, while keeping the concentration of a second component constant.

FIG. 8 shows the effect on the viscosity of adding Ca²⁺ to a fluid containing a viscoelastic surfactant and a rheology enhancer of the invention and then reacting some or all of the Ca²⁺ with Na₂CO₃.

FIG. 9 shows the effect of additional Na₂CO₃ on the viscosity of a fluid containing a viscoelastic surfactant and a rheology enhancer of the invention.

### DETAILED DESCRIPTION OF THE INVENTION

Viscoelastic surfactant fluid systems have been shown to have excellent Theological properties for various applications outside of oilfield applications. As used herein the terms “non-oilfield applications” or excludes hydraulic fracturing; subsurface hydrocarbon deposit applications; and oilfield service applications and the term “non-oilfield excavation applications” or “non-oilfield excavation” means generally excavations of geologic formations involving digging, drilling, blasting, dredging, tunneling, and the like, for example in the course of constructing roads, bridges, buildings, mines, tunnels and the like.

The fluid of this invention is particularly useful in the handling of particles of solid matter generated during the excavation of a geologic formation. The particles are mixed with the viscoelastic fluid by means which are effective to disperse the particles in the fluid. The particles generally have a particle size ranging from a fine powder to coarse gravel, e.g. dust, sand, and gravel. Particle size affects the suspend ability of excavation processing wastes. For example, small particles suspend better than large particles, and very fine particles suspend so well that the mixture may become too thick to transport by pump or similar means. The distribution of excavation processing waste sizes is also important, as waste which contains particles which span a wide range of sizes is more easily suspended than waste wherein the particles are of about the same size. Therefore, it may be preferred to screen the waste particles prior to applying the present method to scalp off the particles that are too large to suspend to obtain a better particle size distribution.

The ability of the excavation tools or systems to hold and remove increased loading of earth is improved by the suspending properties and lubricating properties of the VES fluid systems of the invention.

In non-oilfield excavation applications shear recovery time, not fluid viscosity, often dictates the minimum concentration of surfactant required. For example, a fluid made with a certain concentration of surfactant may show adequate viscosity for tunnel boring, civil engineering drilling, and trenching, but the minimal usable concentration may be high due to slow shear recovery with a lower concentration. Shortening the viscosity-recovery time makes it possible to use VES fluid systems that would otherwise not be suitable in many non-oilfield applications.

For tunnel boring, in situations where the soil contains a high amount of water, the use of VES fluid systems of the invention can prevent the unwanted flow of soil or water behind the shield due to the reduced water permeability of the soil to water and to the modification of the pliability of the soil. For civil engineering drilling and trenching, a VES fluid systems of the invention will minimize the risk of collapse of the trench walls and can help reduce the loss of fluid into the porous formation.

In addition, when a rheology enhancer also increases fluid viscosity, then less surfactant is needed to provide a given viscosity. Examples of other suitable rheology enhancers are provided in U.S. patent application Ser. No. 10/994,664 which is hereby incorporated by reference in its entirety.

We have previously found that certain simple additives, when included in certain VES fluid systems (such as cationic, amphoteric, and zwitterionic surfactants, especially betaine containing VES fluid systems), in the proper concentration relative to the surfactant active ingredient, significantly shorten the shear recovery time of the systems thereby increasing the viscosity at the same time. In many cases, the shear recovery is nearly instantaneous.

We have now found novel rheology enhancer that includes a pair of chemical additives that together are particularly effective for shortening the rehealing time of VES fluid systems after high shear, and increasing the viscosity of VES fluid systems at a given temperature, making the fluids system more useful for many non-oilfield excavation applications. The rheology enhancers of the invention extend the conditions under which the VES fluids systems can be used, and reduces the amount of surfactant needed, which in turn reduces cost.

We have found that the incorporation at the cutting head of one fluid or foam containing a rheology enhanced VES fluid system of the invention helps solve soil pliability problems. The fast rehealing properties of the VES fluid systems of the invention allow for a single injection, which is a more cost effective solution, since the amount of injected surfactants can be reduced. The use of VES fluid systems of the invention can help plasticize the soil to facilitate move-ability through a cutting head into an excavation chamber. Accordingly, when the pliable soil reaches the screw conveyor, the recovered viscosity of the soil makes it easy to be processed and removed.

Another benefit achieved by the invention is reduced water permeability of the soil which reduces the risk of having unwanted water flow during the boring process.

We have also discovered that in civil engineering practice of slurry trench excavation, VES fluid systems of the invention are particularly useful because of their fast rehealing properties. For example, granular bentonites are commonly used to prepare aqueous drilling fluids that are necessary to lubricate drill pipes and provide positive hydrostatic support to the walls of a trench both during the excavation process and during the backfilling processes where the final hardening slurry displaces the bentonite slurry. The use of bentonite slurries has some drawbacks like propensity to clog the pumps and drill pipes caused by rapid swelling of the bentonite.

These negatives can be fixed by using a drilling fluid in accordance with the invention with reduced amounts of bentonite, whereby the bentonite is suspended in the VES fluids system. The fast recovery of a VES fluids system according to the invention when used in conjunction with bentonite can lead to reduction of fluid loss in porous formations during drilling processes and prevent walls from collapsing immediately after the drilling. Another benefit resulting from the bentonite particles suspension in the VES fluids system over extended periods of time is the ability to protect the walls from collapsing over extended periods of inactivity. Still another advantage is the use of reduced amounts of bentonite which simplifies handling, storage, and removal of the bentonite granules on the site.

One component of a rheology enhancer of the invention is, for example, a block copolymer of polyethylene glycol (which will be abbreviated PEG) and polypropylene glycol (which will be abbreviated (PPG). (Note that polyethylene glycol is also known as polyethylene oxide and polypropylene glycol is also known as polypropylene oxide.) The PEG and PPG blocks are connected by ether linkages (with the oxygen coming from the end PEG or PPG of one of the blocks) and terminate with —OH groups (with the oxygen coming from the end PEG or PPG of one of the blocks). The block copolymers may be of the structure PPG-PEG-PPG, PEG-PPG-PEG, or PPG-PEG, where it is understood that PPG-PEG-PPG for example is shorthand for:
HO—(PO)ₓ-(EO)_{y}—(PO)_{z}—OH
where PO is propylene oxide and EO is ethylene oxide. Typically, x=z, and x is from 3 to about 1000 and y is from 3 to about 1000. These polymers be linear, or the overall polymer or individual blocks may be branched, or may have a comb, dendritic, brush, graft, star or star-branched shape. The linear polymers are preferred. The overall polymers or the individual blocks may contain other monomers or polymers such as vinyl esters, vinyl acrylates, and the corresponding hydrolyzed groups, and if so they may be random, alternating, or block copolymers. When they contain other polymers, the amount must be sufficiently small that the hydrophobicity or hydrophilicity of each part of the polymer is not affected enough to excessively decrease the effectiveness of the polymer.

Examples of these block copolymers having PEG inner blocks having symmetrical PPG blocks (outer blocks) on either end include the symmetric block copolymers ANTAROX™ 17-R-2 and ANTAROX™ 31-R-1, available from Rhodia, Inc., Cranbury, N.J., U. S. A. In this terminology, the first number is an arbitrary code number based on the average numerical values of x and y, the letter R indicates that the central block is PEG, and the second number indicates the approximate average mole ratio of PO:EO monomer units. Thus ANTAROX™ 17-R-2 is HO—(PO)ₓ-(EO)_{y}—(PO)—OH in which x=12 and y=9, and in ANTAROX™ 31-R-1, x=21 and y=7. The molecular weights of these examples are less than 3000. Preferred molecular weights range from about 1000 to about 18,000. These materials are also known as “Meroxapol's”. The corresponding materials having a PPG core (inner block) and two symmetrical PEG blocks (outer blocks) are known as Poloxamer's”. Examples of these block copolymers are also sold by BASF under the name PLURONIC™ (with different rules for the codes in the names) with approximately 10 to 80% polyoxyethylene, and average molecular weights ranging from about 1100 to about 17,400. We have shown the structures of these polymers as having hydroxyl groups at both ends, which would be the case if they are manufactured by certain methods. If they are manufactured by other methods, then one termination could be hydroxyl and one could be hydrogen, or both could be hydrogen. It is to be understood that when we show any one such structure, we intend it to represent one having any combination of —OH and —H terminal groups. Also, these block copolymers may have saturated or unsaturated, linear or branched, alkyl groups, having from one to about 12, preferably from one to about 4, carbon atoms, at either or both ends. Some of these block copolymers are known to promote foaming, and some are known to promote defoaming. Suitable block copolymers may be chosen with these functions in mind.

The second component of the rheology enhancer of the invention is, for example, a polynaphthalene sulfonate such as DAXAD™ 17 and DAXAD™ 19, available from GEO Specialty Chemicals, Cleveland, OH,; these materials are available as liquid concentrates and as solids and may also contain small amounts of sodium formate, sodium 2-naphthalenesulfonic acid, water, and sodium sulfate. These materials differ in their molecular weights; for example, DAXAD™ 17 has a molecular weight of about 30000, and DAXAD™ 19 has a molecular weight of about 70000. Suitable polynaphthalene sulfonate polymers have a molecular weight of from about 5000 to about 500,000.

The principal role of the block copolymer is to shorten the shear recovery time of the VES fluid systems; it also increases the viscosity under certain shear and temperature conditions. The principal role of the polynaphthalene sulfonate is to increase the viscosity, especially at intermediate temperatures. Preferred concentrations of the rheology enhancer are from about 0.005 weight % to about 1 weight %, for example from about 0.01 weight % to about 0.5 weight % (of the “as-received” materials in the final fluid). More preferred concentrations of the rheology enhancer of the invention are from about 0.1% to about 10% of the concentration of active VES fluid systems, for example from about 0.5% to about 7%. Suitable weight ratios of the block copolymer to the polynaphthalene sulfonate range from about 1:5 to about 1:1.

The rheology enhancer of the invention give the desired results with cationic, amphoteric, and zwitterionic VES fluid systems. They have been found to be particularly effective with certain zwitterionic surfactants. In general, particularly suitable zwitterionic surfactants have the formula:
RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻
in which R is an alkyl group that contains from about 17 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂.

Preferred zwitterionic surfactants include betaines. Two suitable examples of betaines are BET-O and BET-E. The surfactant in BET-O-30 is shown below. One chemical name is for BET-O-30 oleylamidopropyl betaine. It is designated BET-O-30 by the supplier (Rhodia, Inc. Cranbury, New Jersey, U. S. A.) and it is sold under the Mirataine BET-O-30 designation because it contains an oleyl acid amide group (including a C₁₇H₃₃ alkene tail group) and contains about 30% active surfactant; the remainder is substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. The surfactant in BET-E-40 is also shown below and has the chemical name erucylamidopropyl betaine. “As-received” concentrates of BET-E-40 were used in the experiments reported below. BET surfactants, and other VES's that are suitable for the invention, are described in U.S. Pat. No. 6,258,859 discloses that BET surfactants form viscoelastic gels when in the presence of certain organic acids, organic acid salts, or inorganic salts.
The patent also describes the presence of inorganic salts at a weight concentration of up to about 30 weight % of the liquid portion of the system. Co-surfactants may be useful in extending the brine tolerance, increase the gel strength, and reduce the shear sensitivity of the VES fluid systems, in particular for BET-O-type surfactants. An example given in U. S. Pat. No. 6,258,859 is sodium dodecylbenzene sulfonate (SDBS), also shown below. Other suitable co-surfactants include, for example those having the SDBS-like structure in which x=5-15; preferred co-surfactants are those in which x=7-15. Still other suitable co-surfactants for BET-O-30 are certain chelating agents such as trisodium hydroxyethylethylenediamine triacetate. The rheology enhancer packages of the present invention may be used with VES fluid systems that contain such additives as co-surfactants, organic acids, organic acid salts, and/or inorganic salts.

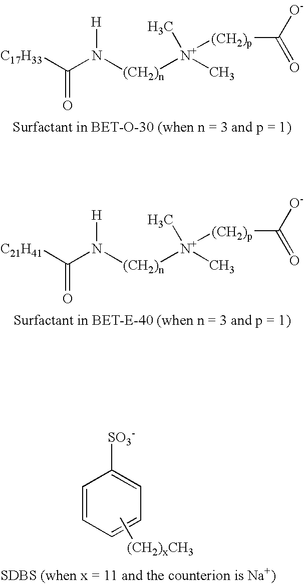

Preferred embodiments of the present invention use betaines; most preferred embodiments use BET-E-40. Although experiments have not been performed, it is believed that mixtures of betaines, especially BET-E-40, with other

Such mixtures are within the scope of embodiments of the invention.

Other betaines that are suitable include those in which the alkene side chain (tail group) contains 17-23 carbon atoms (not counting the carbonyl carbon atom) which may be branched or straight chained and which may be saturated or unsaturated, n=2-10, and p=1-5, and mixtures of these compounds. More preferred betaines are those in which the alkene side chain contains 17-21 carbon atoms (not counting the carbonyl carbon atom) which may be branched or straight chained and which may be saturated or unsaturated, n=3-5, and p=1-3, and mixtures of these compounds. These surfactants are used at a concentration of about 0.5 to about 5 weight %, preferably from about 1 to about 2.5 weight % (concentration of as-received viscoelastic surfactant concentrate in the fluid).

Exemplary cationic viscoelastic surfactants include the amine salts and quaternary amine salts disclosed in U.S. Pat. Nos. 5,979,557, and 6,435,277 which have a common inventor as the present application and which are hereby incorporated by reference in its entirety.

Examples of suitable cationic viscoelastic surfactants include cationic surfactants having the structure:
R₁N⁺(R₂)(R₃)(R₄) X⁻
in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Cationic surfactants having the structure R₁N⁺(R₂)(R₃)(R₄) X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). “As-received” commercially available VES concentrate formulations, for example cationic VES concentrate formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members.

Another suitable cationic VES is erucyl bis(2-hydroxyethyl) methyl ammonium chloride, also known as (Z)-13 docosenyl-N-N- bis (2-hydroxyethyl) methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination in accordance with the invention), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Many fluids made with VES fluid systems, for example those containing cationic surfactants having structures similar to that of erucyl bis(2-hydroxyethyl) methyl ammonium chloride, inherently have short reheal times and the rheology enhancer of the invention may not be needed except under special circumstances, for example at very low temperature.

Amphoteric VES is also suitable. Exemplary amphoteric VES fluid systems include those described in U.S. Pat. No. 6,703,352, for example amine oxides. Other exemplary VES fluid systems include those described in U.S. patent application Ser. Nos. 2002/0147114, 2005/0067165, and 2005/0137095, include amidoamine oxides. These four references are hereby incorporated by reference in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide (these are weight percents of a concentrate used to make the final fluid).

VES fluid systems for use in industrial cleaning applications may also contain suitable agents that dissolve minerals, such as scale and silica. Suitable agents may include, for example, hydrochloric acid, formic acid, acetic acid, lactic acid, glycolic acid, sulfamic acid, malic acid, citric acid, tartaric acid, maleic acid, methyl sulfamic acid, chloroacetic acid, aminopolycarboxylic acid, 3 hydroxypropionic acid, polyamino polycarboxylic acid for example trisodium hydroxyethylene diamine triacetate, and salts of these acids and mixtures of these acids and or salts. VES fluid systems for use in industrial cleaning applications may optionally contain chelating agents for polyvalent cations to prevent their precipitation. Suitable chelating agents may include, for example, aluminum, calcium and iron.

Preparation and use (i.e., mixing, storing, pumping, etc.) of the VES containing a rheology enhancer of the invention are the same as for fluids without the rheology enhancer. For example, the order of mixing of the components in the liquid phase is not affected by including rheology enhancers in accordance with the invention. Optionally, a rheology enhancer of the invention may be incorporated in surfactant concentrates (provided that they do not affect component solubility or concentrate freezing points) so that the concentrates can be diluted with an aqueous fluid to make a VES fluid system. This maintains the operational simplicity of the VES fluid system.

Alternatively, a rheology enhancer in accordance with the invention may be provided as separate concentrates in solvents such as water, isopropanol, and mixtures of these or other solvents. An active rheology enhancer in such a concentrate is, for example, from about 10 to about 50% by weight, for example from about 10 to about 40 weight %. As is normally the case in fluid formulation, laboratory tests should be run to ensure that the additives do not affect, and are not affected by, other components in the fluid (such as salts, for example). In particular, a rheology enhancer of the invention may be used with other rheology modifiers. Adjusting the concentrations of surfactant, rheology enhancer, and other fluid components to account for the effects of other components is within the scope of the invention.

VES fluid systems according to the invention or foams prepared by combining a VES fluid system of the invention with anionic surfactants are particularly suitable for use in tunnel boring applications. Suitable anionic surfactants include sulfated or sulphonated anionic based surfactants. Preferred anionic surfactants include polyalkylene alkyl ether sulfate, ammonium lauryl ether sulfate, alpha olefin sulfonates, fatty alcohols sulfate salts and fatty alcohol ether sulfate salts. The VES fluid systems according to the invention can be used in combination with bentonite in civil engineering drilling and trenching practice. Dispersions of solid matter, preferably bentonite, can be used to provide hydrostatic support to the walls of a trench during civil engineering excavation and backfilling processes.

Rheology enhanced VES fluids systems of the invention may also be useful in the following applications:
a) the manufacture of low density materials, for example, pre-cast slabs, ceramics, or the like;
b) high pressure cleaners such as industrial cleaners, automobile (for example, trucks and car) cleaners (Rheology enhanced VES fluid systems of the invention are particularly useful where a fluids or foams needs to stick on to vertical surfaces to improve the cleaning);
c) industrial formulations, for example, industrial cleaners and polishing slurries, where there is a need to suspend high density materials, including, for example, oxides or salts such as silica, titanium oxide, aluminum oxide, cerium oxide, barium sulfate, or combinations thereof in a solution or foam;
d) personal care applications, for example, hair dyes, body wash, facial wash, shampoos, hair conditioners, or styling formulations;
e) home care applications, for example, toilet bowl cleaners, bleaches, or air fresheners;

f) oral care formulations, for example, toothpaste, or mouthwash;

g) wet wipes designed for home care, personal care and baby care, where there is a need to provide, at low surfactant levels, a gel to suspend actives such as particles, oils, biocides, benefits agents to skin for skin care or healing; and
h) agricultural spray formulations for example as a tank mix adjuvant or as a part of a formulation containing biologically active substances, or as a combination of both.

The optimal concentration of a given rheology enhancer of the invention for a given choice of VES fluid system at a given concentration and temperature, and with given other materials present can be determined by simple experiments. The total VES concentration must be sufficient to form a stable fluid with suitable shear recovery time under conditions (time and temperature) at which the system will be used. The appropriate amounts of surfactant and rheology enhancer are those necessary to achieve the desired stability and shear reheal time as determined by experiment.

Again, tolerance for, and optimal amounts of other additives may also be determined by simple experiment. In general, the amount of surfactant (as-received VES concentrate in the fluid) is from about 0.5 to about 10 weight %, preferably from about 1 to about 5 weight %. Commercially available surfactant concentrates may contain some materials that are themselves rheology modifiers, although they may be present for example for concentrate freezing point depression, so the amount of surfactant and rheology enhancer used is determined for the specific concentrate used. Mixtures of surfactants and/or mixtures of multiple rheology enhancers of the invention may be used. Mixtures of surfactants may include surfactants that are not viscoelastic when not part of a VES fluid system. All mixtures are tested and optimized. For example, too much total rheology enhancer may decrease the beneficial effects.

Experimental: The present invention can be further understood from the following examples. In the examples, the zwitterionic surfactant concentrate BET-E-40 is designated “VES-30”. ANTAROX™ 17-R-2 is designated “A-17” and ANTAROX™ 31-R-1 is designated “A-31”. DAXAD™ 17 is designated “D-17” and DAXAD™ 19 is designated “D-19”. Concentrations given were weight % of the “as-received” materials in the final fluid, except for the concentrations of the DAXAD's, which were given as weight % of the polymer in the final fluid.

### EXAMPLE 1

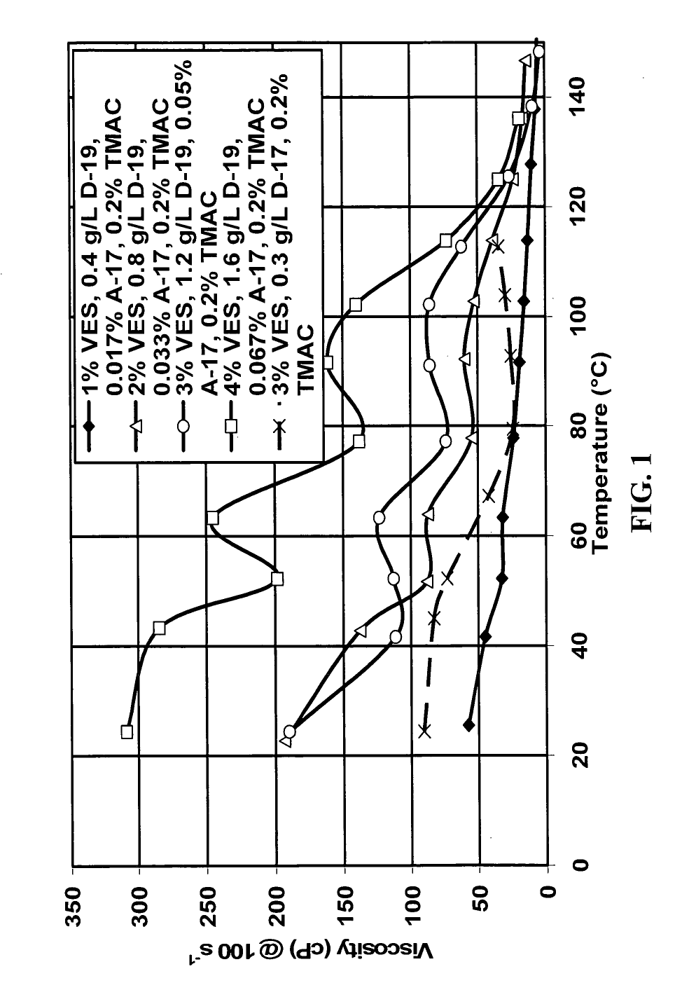

FIG. 1 shows the viscosity as a function of temperature for various concentrations of VES-30 containing the rheology enhancer D-19 plus A-17. The weight ratios of VES-30:D-19:A-17 were constant. The profiles are compared to that for 3% VES-30 containing D-17 and no block copolymer additive. Tetramethylammonium chloride (TMAC) was added as a clay stabilizer, because these fluids perform better with TMAC than with other clay stabilizers such as KCl. It can be seen that the viscosities increased with increasing concentrations of VES-30 containing this rheology enhancer; the viscosity with only 2% VES-30 and this package was higher than with 3% VES-30 containing only D-17. At intermediate temperatures, the viscosity with only 1% VES-30 and this package was about the same as with 3% VES-30 containing only D-17.

### EXAMPLE 2

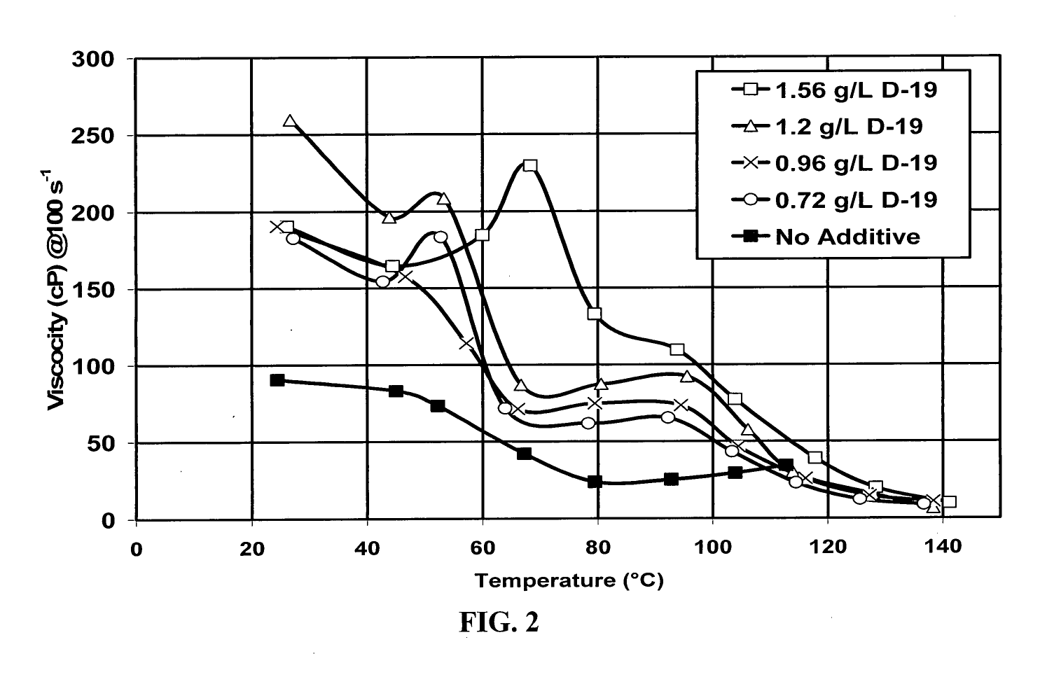

FIG. 2 shows the viscosity as a function of temperature for VES fluid systems containing 3% by weight “as-received” VES-30, 0.08% by weight “as-received” A-17, and varying amounts of D-19 in 2% TMAC. It can be seen that at temperatures below about 110° C. increasing amounts of D-19 increased the viscosity of the fluid.

### EXAMPLE 3

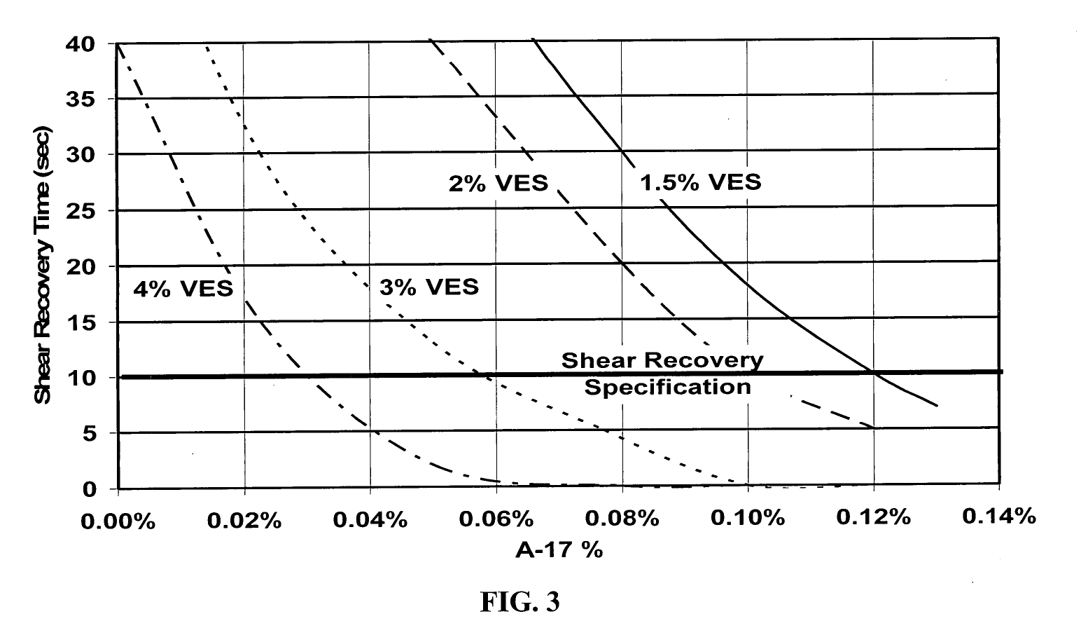

The shear recovery times were determined in experiments in which approximately 200 mL of already-mixed VES-30 fluid was sheared at no less than 10,000 rpm for no less than 30 seconds and no more than 1 minute in a 1 L Waring blender. The shearing was stopped and timing was begun. The fluid was poured back and forth between a beaker and the blender cup and fluid rehealing was characterized by an initial and final recovery time. Both times were estimated by visual observation. The initial fluid recovery time was the time at which fluid “balling” occurred (i.e., when the fluid showed the first signs of elasticity as indicated by the fluid taking a longer time to achieve a flat surface in the receiving beaker when poured). The final fluid recovery time was the time at which fluid “lipping” occurred. The fluid “lips” when inclining the upper beaker or cup containing the fluid does not result in fluid flow into the container below, but rather the formation of a “lip,” and pulling the upper container back to a vertical position pulls the “lip” back into the upper container. “Lipping” is used to estimate when the fluid reaches its near-equilibrium elasticity. FIG. 3 shows the effect of A-17 concentration on the shear recovery time of a VES fluid system containing four different concentrations of VES-30, a constant weight ratio of VES-30 to D-19 of 25:1, and varying amounts of A-17. It can be seen that increasing amounts of the block copolymer were required to reduce the shear recovery time to less than 10 seconds as the concentration of the VES was decreased. However, the target of less than 10 seconds was achieved at all VES-30 concentrations with very low A-17 concentrations.

### EXAMPLE 4

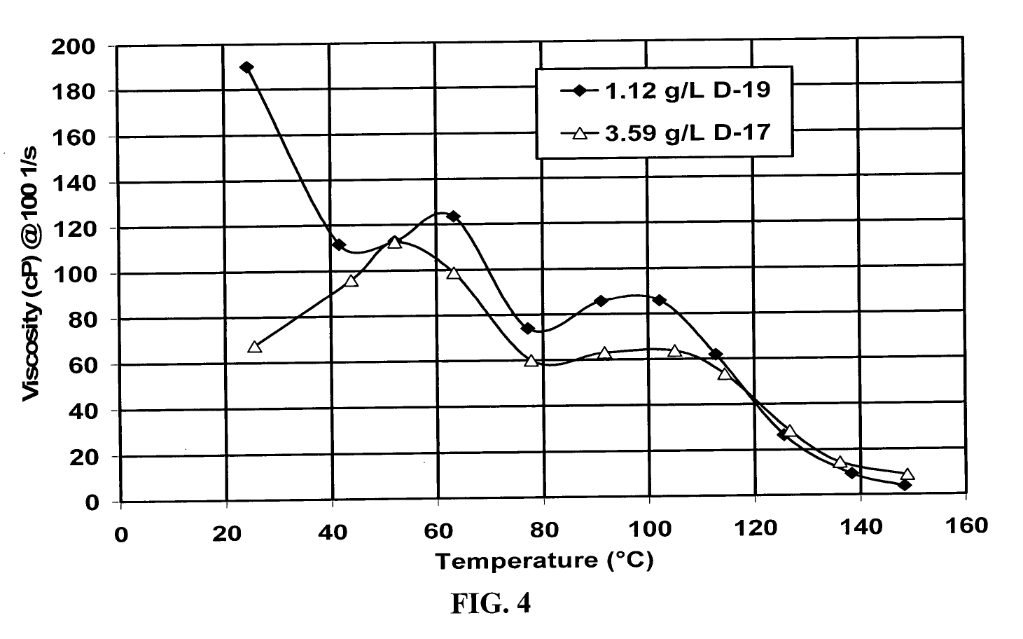

FIG. 4 compares the viscosities of VES fluid systems made with 3% VES-30, 0.05% A-17, and either D-17 or D-19. It can be seen that less than one third the concentration of D-19 gave better viscosity than D-17. Furthermore, the final shear recovery for the system with D-17 was more than 300 seconds, but the final shear recovery for the system with the D-19 was only 11 seconds.

### EXAMPLE 5

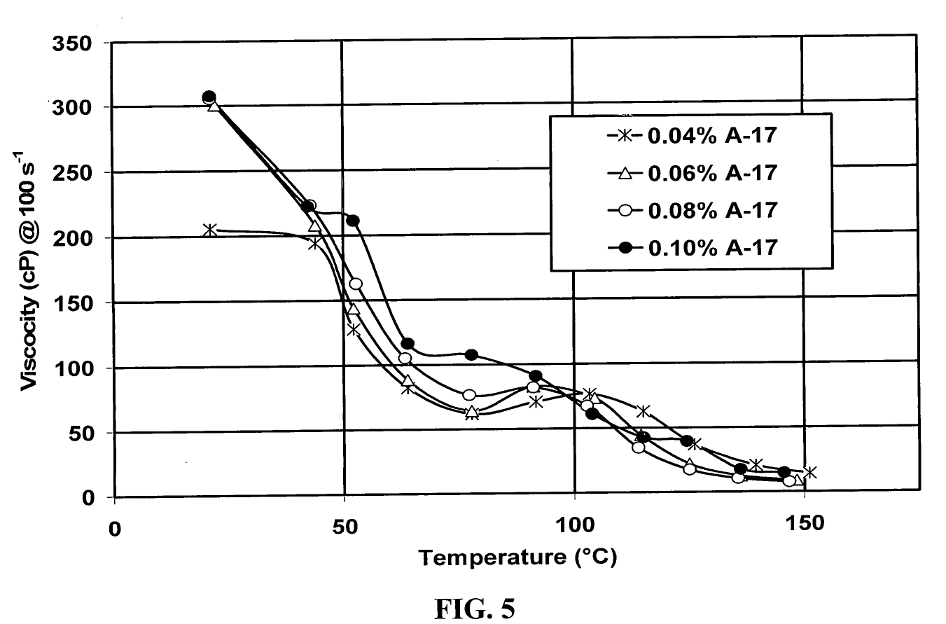

FIG. 5 shows the effect of A-17 concentration on VES fluid systems containing 3% VES-30 and 0.12% D-17. It can be seen that at temperatures below about 95° C., increasing A-17 slightly increased the viscosity, while at temperatures above about 95° C., there was almost no effect.

### EXAMPLE 6

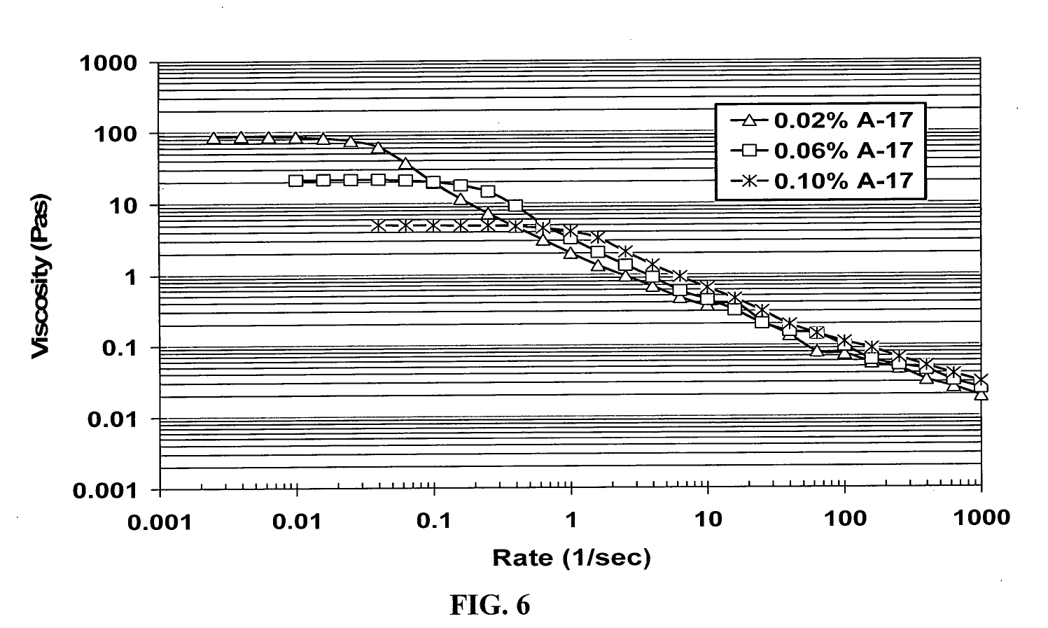

FIG. 6 shows the effect of varying the concentration of A-17 on the low shear viscosity of a fluid containing 3% VES-30, 0.12% D-19, and 0.2% TMAC. It can be seen that increasing amounts of A-17 decreased the low shear viscosity and increased the shear rate at which the viscosity leveled off.

### EXAMPLE 7

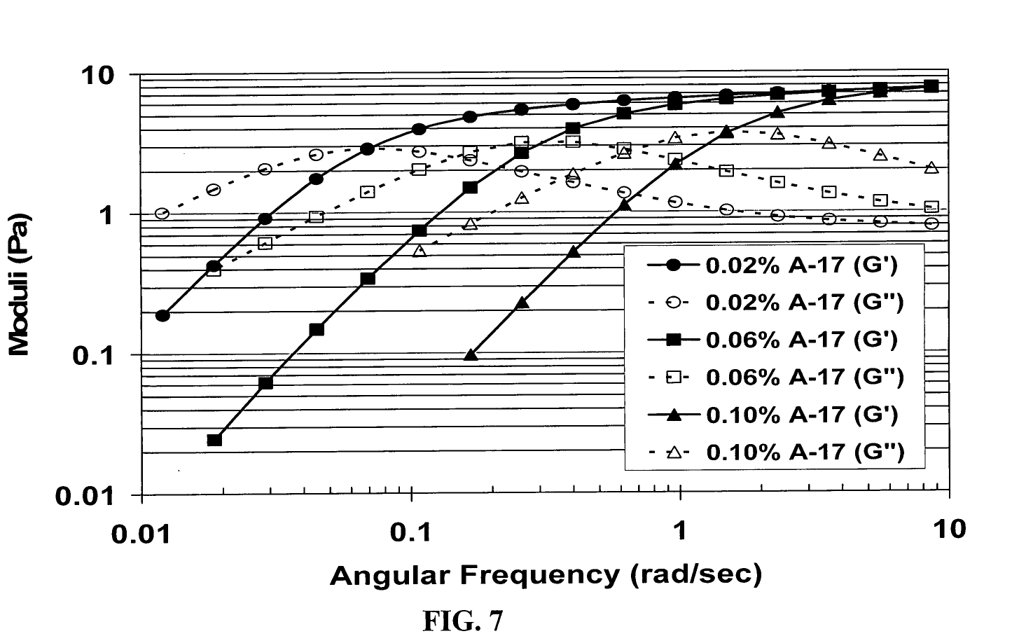

FIG. 7 shows the dynamic loss modulus and the dynamic storage modulus of fluids containing 3% VES-30, 0.12% D-19, 0.2% TMAC, and varying amounts of A-17. An increase in the concentration of A-17 increased the cross over frequency of the two moduli, which in turn indicated shorter relaxation times. The longer the relaxation time, the more the fluid behaved like a gel.

### EXAMPLE 8

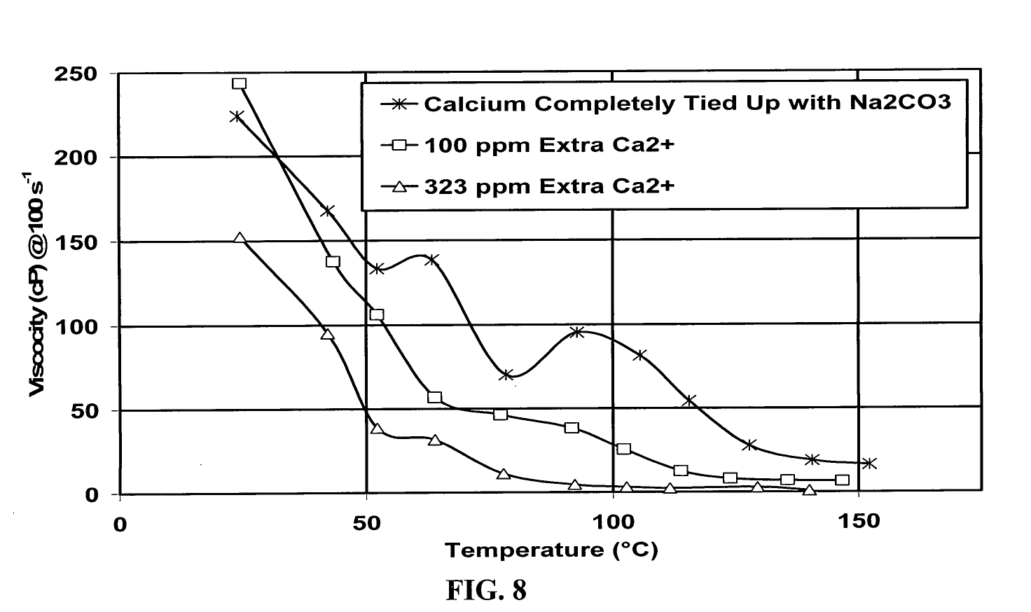

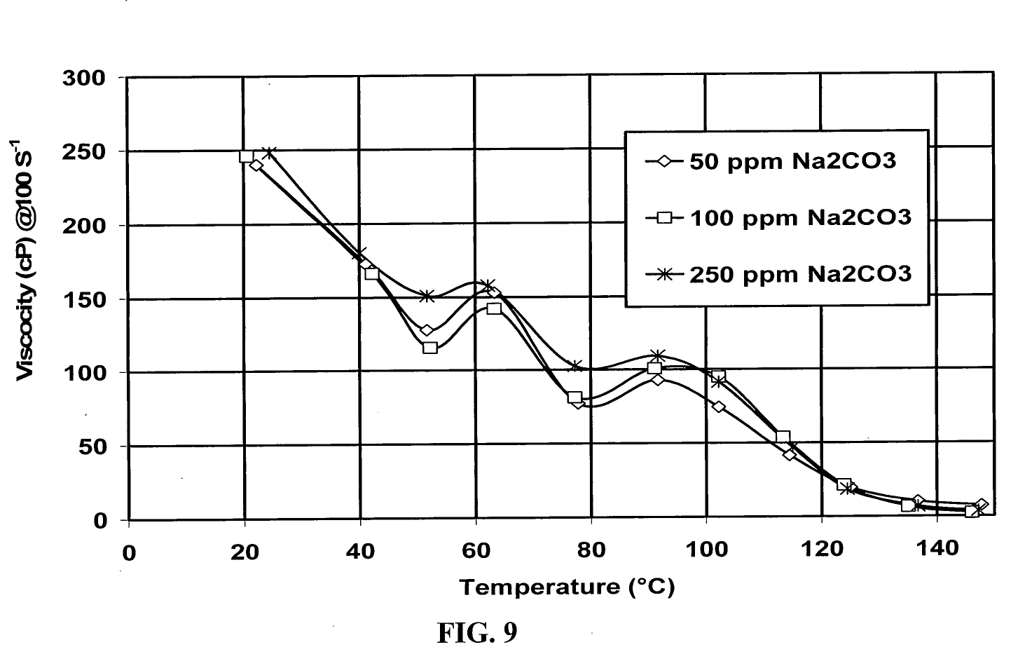

VES fluid systems are somewhat sensitive to calcium ions. FIG. 8 shows the effect of adding about 40 ppm (parts per million) of Ca²⁺ to a fluid containing 3% VES-30, 0.12% D-19, 0.05% A-17, and 0.2% TMAC and then adding an amount of Na₂CO₃ sufficient to react completely with the Ca²⁺. The viscosity was satisfactory. However, if there was excess Ca²⁺, then the viscosity was substantially reduced. On the other hand, excess Na₂CO₃ did not cause any problems, as shown in FIG. 9 for a VES fluid system containing 3% VES-30, 0.12% D-19, 0.05% A-17, 0.2% TMAC, and varying amounts of Na₂CO₃, so clearly it is easy to control Ca⁺ with Na₂CO₃.

We claim:

1. A fluid comprising:
a. a viscoelastic surfactant selected from the group consisting of zwitterionic, amphoteric, and cationic surfactants and mixtures thereof,
b. a rheology enhancer in an amount sufficient to increase the rate of shear rehealing of said fluid, said rheology enhancer comprising a first component comprising a block copolymer of polypropylene glycol and polyethylene glycol; and a second component comprising a polynaphthalene sulfonate, and
c. a liquid carrier

2. The fluid of claim 1 wherein said fluid is viscoelastic.

3. The fluid of claim 1 further comprising a foaming agent.

4. The fluid of claim 1 wherein said liquid carrier comprises water.

5. The fluid of claim 1 further comprising a foam forming surfactant.

6. The fluid of claim 1 further comprising an anionic surfactant.

7. The fluid of claim 6 wherein said anionic surfactant comprises a sulfated surfactant, a sulphonated surfactant, or a combination of sulfated and sulphonated surfactants.

8. The fluid of claim 6 wherein said anionic surfactant comprises at least polyalkylene alkyl ether sulfate, ammonium lauryl ether sulfate, alpha olefin sulfonates, fatty alcohols sulfate salts, fatty alcohol ether sulfate salts, or combinations thereof.

9. A process of forming a fluid for non-oilfield applications comprising the steps of:
i). mixing at least a surfactant composition comprising a) a surfactant selected from the group consisting of zwitterionic, amphoteric, cationic, and mixtures thereof, and b) a rheology enhancer composition present in an amount sufficient to increase the rate of shear recovery, wherein said rheology enhancer composition comprises at least a block copolymer of polypropylene glycol and polyethylene glycol, and a polynaphthalene sulfonate to form a rheology enhancer containing surfactant system;
ii). adding an aqueous based solution to said rheology enhancer containing surfactant system to form a fluid.

10. The process of claim 9 wherein said rheology enhancer containing surfactant system is non-viscous.

11. The process of claim 10 further comprising the step of increasing the viscosity of said fluid by agitating said fluid to form a viscoelastic fluid system.

12. The process of claim 11 wherein said rheology enhancer containing surfactant system is a concentrate.

13. The process of claim 11 wherein said rheology enhancer containing surfactant system is a fluid concentrate.

14. The process of claim 11 further comprising adding an amount of an anionic surfactant sufficient to cause said viscoelastic fluid system to form foam.

15. The process of claim 11 further comprising the step of adding solid matter to said viscoelastic fluid system to form an excavation fluid.

16. The process of claim 14 further comprising the steps of adding solid matter to said viscoelastic fluid system and forming a foamed excavation fluid.

17. The process of claim 15 or 16 wherein said solid matter is suspended in said viscoelastic fluid system of said excavation fluid.

18. The process of claim 16 wherein said foamed excavation fluid where foam is used for manufacturing low density materials.

19. A method of treating a non-oilfield excavation site comprising:
a). providing a viscoelastic surfactant composition comprising at least a zwitterionic surfactant, amphoteric surfactant, cationic surfactant or combination thereof;
b). adding a rheology enhancer to said viscoelastic surfactant composition, wherein said rheology enhancer package comprises at least a polynaphthalene sulfonate component and a block copolymer component, wherein said block copolymer component comprises polypropylene glycol and polyethylene glycol;
c). mixing said viscoelastic surfactant composition and said rheology enhancer to form a fluid having viscoelastic properties.
d) injecting said fluid into a non-oilfield excavation application.

20. The method of claim 19 further comprising adding solid matter to said fluid to form a dispersion of said solid matter in said fluid before injecting said fluid into said non-oilfield excavation site.

21. The method of claim 19 further comprising diluting said dispersion of solid matter in said fluid with an aqueous solution to obtain a selected rheology profile.

22. The method of claim 20 wherein said rheology enhancer is added in an amount sufficient to increase the rate of shear rehealing of said fluid.

23. The method of claim 21 wherein fluid is used as drilling fluid.

24. The method of claim 21 further comprising removing said fluid from said excavation site via a conveying means.

25. The process of claim 21 further comprising using said fluid to provide a hydrostatic support to walls of a trench during an excavation or backfilling process.

26. A personal care formulation comprising the fluid of claim 1.

27. An oral care formulation comprising the fluid of claim 1.

28. A home care formulation comprising the fluid of claim 1.

29. Wet wipes comprising the fluid of claim 1.

30. Skin care formulations comprising the fluid of claim 1.

31. Pharmaceutical actives comprising the fluid of claim 1.

32. An agricultural formulation comprising the fluid of claim 1.
